(19) United States
(12) Patent Application Publication
(10) Pub. No.: US 2011/0295951 A1
(43) Pub. Date: Dec. 1, 2011

(54) METHOD, LOGIN SERVER, MEETING SERVER AND PC CLIENT FOR HOLDING MEETING WHEN PC CLIENT IS BOUND WITH HARD TERMINAL

(75) Inventor: Jianjun Yang, Guangdong Province (CN)

(73) Assignee: ZTE CORPORATION, Shenzhen, Guangdong Province (CN)

(21) Appl. No.: 13/139,999

(22) PCT Filed: Aug. 11, 2009
(86) PCT No.: PCT/CN09/73178

§ 371 Date: Aug. 12, 2011

(30) Foreign Application Priority Data
Dec. 16, 2008 (CN) 200810241249.6

(51) Int. Cl. G06F 15/16

(52) U.S. Cl. 709/204

(57) ABSTRACT

The present invention discloses a method for holding a meeting when a PC client is bound with a hard terminal, a login server, a meeting server and a PC client. The method comprises: the PC client obtaining address information of a meeting server from a login server; establishing a signaling channel between the PC client and the meeting server according to the address information; and the PC client sending a meeting control signaling message to the meeting server through the signaling channel to control the meeting. In the present invention, the PC client obtains the address information of the meeting server from the login server when the user logs in, and then directly establishes the signaling channel between the PC client and the meeting server according to the address information, so that the PC client can send the meeting control signaling message to the meeting server through the signaling channel to control the meeting, and the function of holding a meeting when the PC client is bound with a hard terminal can be realized.

### FIELD OF THE INVENTION

The present invention relates to the intelligent network communication field, in particular to a method, a login server, a meeting server and a PC client for holding a meeting in a next generation network (NGN) or an IP multimedia subsystem (IMS) when the PC client is bound with a hard terminal.

### BACKGROUND OF THE INVENTION

With the construction of the NGN or the IMS network, a unified communication mode based on a desktop PC client is paid more and more attention by all operators.

When bound with a soft terminal, the PC client can be used as a soft terminal after the PC client registers with a core network. Such flow of holding a meeting is detailed in individual standards.

With reference to FIG. 1, FIG. 1 shows a flow of the method for holding an instant meeting when the PC client is bound with a soft terminal. The method concretely comprises the steps as follows.

101-102, the PC client sends a soft terminal registration request to the core network; the core network returns a registration success message after receiving the registration request, such that a signaling channel is established between the PC client and the core network.

103-107, the PC client sends an instant meeting invite message to the core network through the signaling channel; the core network, after receiving the instant meeting invite message, notifies the meeting server to establish an instant meeting; and the meeting server establishes an instant meeting, and returns a meeting establishment success message to the PC client through the core network.

108-114, the PC client sends a refer add terminal message to the core network through the signaling channel; the core network, after receiving the refer add terminal message, accesses each meeting member into the meeting through the meeting server; and the meeting server returns state information of the meeting and the meeting members to the PC client through the core network.

115, the PC client sends other meeting control information to the core network through the signaling network; and then the core network performs corresponding meeting control operations through the meeting server.

With reference to FIG. 2, FIG. 2 shows a flow of the method for holding an appointment meeting when the PC client is bound with a soft terminal. The method concretely comprises the steps as follows.

201-202, the PC client sends a soft terminal registration request to the core network; and the core network returns a registration success message after receiving the registration request, such that a signaling channel is established between the PC client and the core network.

203-209, the PC client sends an appointment meeting invite message (in which an appointment list is carried) to the core network through the signaling channel; the core network, after receiving the appointment meeting invite message, notifies the meeting server to establish an appointment meeting; and the meeting server, after receiving the notification, establishes the appointment meeting and returns a meeting establishment success message to the PC client through the core network.

210-217, when the time for holding the appointment meeting arrives, the meeting server sends a meeting presider invite message to the core network; the core network invites the PC client to join the meeting; the PC client then sends a refer add terminal message to the core network through the signaling channel; the core network, after receiving the refer add terminal message, accesses each meeting member into the meeting through the meeting server; and then the meeting server returns state information of the meeting and the meeting members to the PC client through the core network.

218, the PC client sends other meeting control information to the core network through the signaling network; and then the core network performs corresponding meeting control operations through the meeting server.

In above-mentioned methods, the PC client itself is a soft terminal which needs to register with the core network. A successful registration means that, the signaling channel is successfully established between the PC client and the core network and the PC client can initiate a call.

However, when the PC client is bound with a hard terminal, the PC client can not register with the core network, and as a result, the channel from the PC client to the core network is obstructed, leading to that standard SIP messages can not be sent to the core network, and moreover the meeting can not be held or controlled. At present, no relevant solution has been put forward yet to solve the problem.

### SUMMARY OF THE PRESENT INVENTION

The present invention aims at solving the technical problem by providing a method for holding a meeting when the PC client is bound with a hard terminal, and a system, a login server, a meeting server and a PC client for realizing the method.

In order to solve the above-mentioned technical problem, the present invention puts forward the following technical solution.

A method for holding a meeting when the PC client is bound with a hard terminal comprises:

the PC client obtaining address information of a meeting server from a login server;

establishing a signaling channel between the PC client and the meeting server according to the address information; and

the PC client sending a meeting control signaling message to the meeting server through the signaling channel to control the meeting.

In the method, the signaling channel can be established in the following manner in which:

the PC client sends an instant meeting establishment request message to the meeting server according to the address information; and the meeting server establishes an instant meeting after receiving the instant meeting establishment request message.

In the method, the instant meeting establishment request message is used for establishing the signaling channel between the PC client and the meeting server.

In the method, the signaling channel can be established in the following manner in which:

the PC client sends an appointment meeting establishment request message to the meeting server according to the address information; and the meeting server establishes an appointment meeting after receiving the appointment meeting establishment request message; and

when time for the appointment meeting arrives, the meeting server sends to the PC client a request message for inviting the PC client to join the meeting, and establishes the signaling channel between the PC client and the meeting server.

The method can also comprise: the meeting server sending state information of the meeting and/or meeting members to the PC client through the signaling channel.

In the method, during the process that the PC client controls the meeting through the meeting server, the meeting server can route the control signaling message of the PC client to each meeting member through a core network.

A system for holding a meeting when the PC client is bound with a hard terminal comprises: a PC client, a login server, and a meeting server; wherein the PC client comprises an address obtaining module;

the address obtaining module is configured to obtain address information of the meeting server from the login server;

the PC client is configured to establish a signaling channel between the PC client and the meeting server according to the address information and to send a meeting control signaling message to the meeting server through the signaling channel;

the meeting server is configured to establish an instant meeting/appointment meeting according to the request of the PC client, and control the meeting according to the meeting control signaling message of the PC client.

The system can also comprise a core network which is configured to realize routing function of the signaling between the meeting server and each meeting member during the process of the meeting control performed by the meeting server.

In the system, the meeting server can also be configured to send state information of the current meeting and/or meeting members to the PC client through the signaling channel.

The present invention provides a login server for holding a meeting when the PC client is bound with a hard terminal. The login server is configured to provide the PC client with address information of a meeting server, so that the PC client is able to establish a signaling channel with the meeting server according to the address information, and send a meeting control signaling message to the meeting server through the signaling channel to control the meeting.

The present invention provides a meeting server for holding a meeting when the PC client is bound with a hard terminal. The meeting server is configured to establish an instant meeting/appointment meeting according to a request from the PC client, and control the meeting according to a meeting control signaling message from the PC client, wherein the address information of the meeting server is obtained from a login server by the PC client, so that the PC client establishes a signaling channel with the meeting server according to the address information.

The present invention provides a PC client for holding a meeting when the PC client is bound with a hard terminal. The PC client comprises an address obtaining module, the address obtaining module is configured to obtain address information of a meeting server from a login server, and the PC client is configured to establish a signaling channel with the meeting server according to the address information, and send a meeting control signaling message to the meeting server through the signaling channel to control the meeting.

In the present invention, the PC client obtains the address information of the meeting server from the login server when the user logs in, and then directly establishes the signaling channel between the PC client and the meeting server according to the address information, so that the PC client can send the meeting control signaling message to the meeting server through the signaling channel to control the meeting, and the function of holding a meeting when the PC client is bound with a hard terminal can be realized.

### BRIEF DESCRIPTION OF THE DRAWINGS

FIG. 1 is a flowchart of the method for holding an instant meeting when the PC client is bound with a soft terminal;

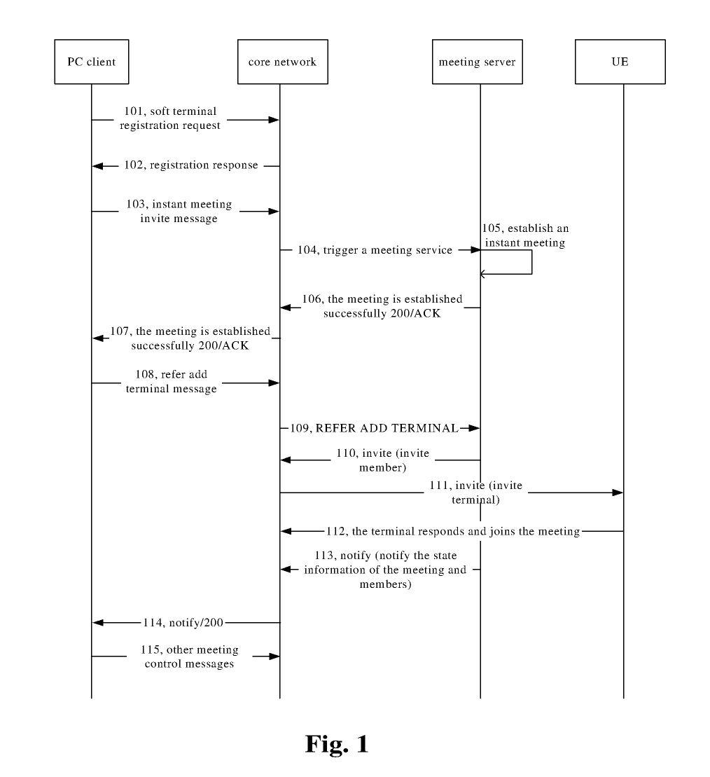

FIG. 2 is a flowchart of the method for holding an appointment meeting when the PC client is bound with a soft terminal;

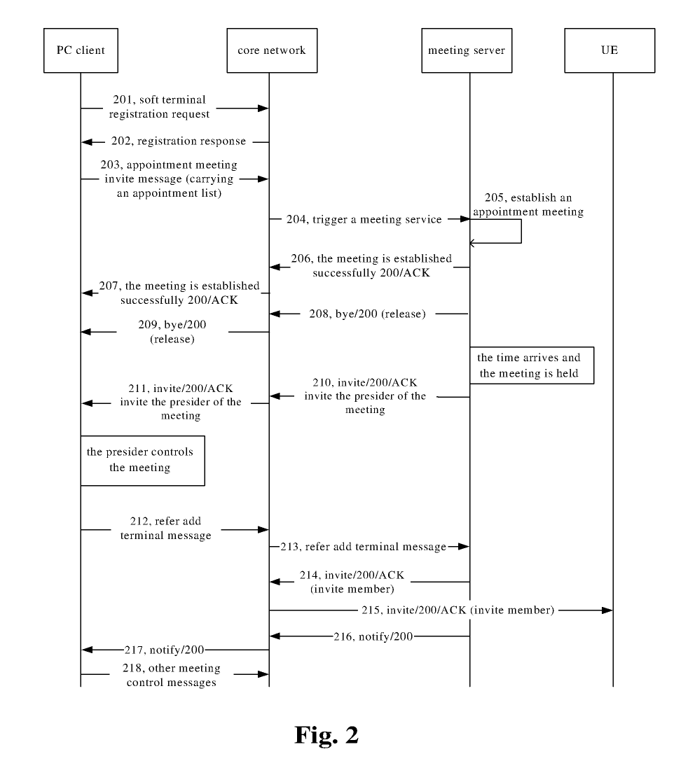

FIG. 3 is a flowchart of the method for holding an instant meeting when the PC client is bound with a hard terminal according to one embodiment of the present invention; and

FIG. 4 is a flowchart of the method for holding an appointment meeting when the PC client is bound with a hard terminal according to one embodiment of the present invention.

### PREFERABLE EMBODIMENTS OF THE PRESENT INVENTION

The present invention will be further detailed hereinafter in connection with the embodiments and drawings of the present invention.

In the embodiment, the system for holding and controlling the meeting when the PC client is bound with a hard terminal comprises a PC client and a hard terminal bound with the PC client, a login server, a meeting server, a core network, and the other meeting members (UE), wherein the PC client comprises an address obtaining module.

The working principle of the system is: when the user logs in the system, the PC client invokes the address obtaining module to obtain address information of the meeting server from the login server; then a signaling channel is established between the PC client and the meeting server according to the address information, meanwhile the meeting server establishes an instant meeting/appointment meeting according to the request of the PC client; afterwards, the PC client sends a meeting control signaling message to the meeting server through the signaling channel to control the instant meeting/appointment meeting, wherein the core network is only used for realizing the routing function of the signaling between the meeting server and the hard terminal bound with the PC client and the other meeting members.

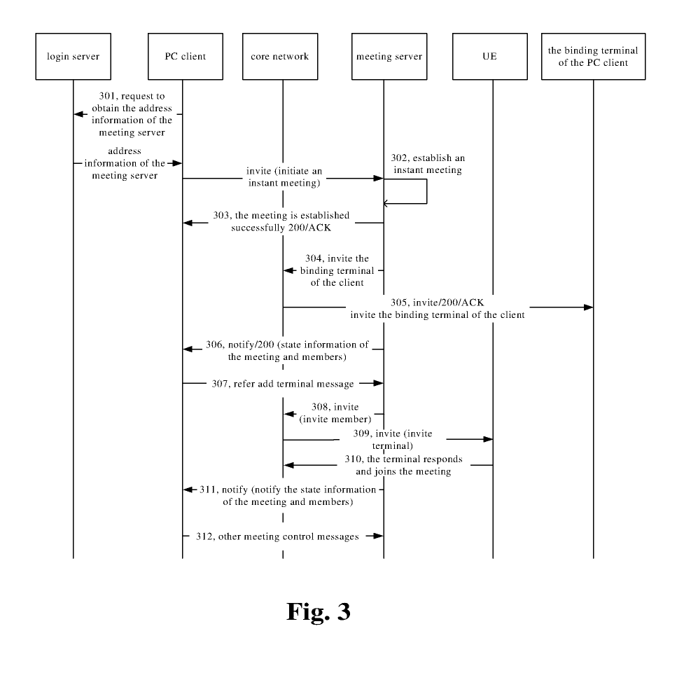

With reference to FIG. 3, FIG. 3 shows a flow of the method for holding an instant meeting when the PC client is bound with a hard terminal according to one embodiment of the present invention. The method concretely comprises the steps as follows.

301, the PC client obtains the address information of the meeting server from the login server, and initiates an instant meeting invite message to the meeting server wherein the media of this invite message is inactive, that is, no media is needed to be transmitted between the PC client and the meeting media server, and the invite message is sent only for establishing a signaling channel.

302, the meeting server identifies the received instant meeting invite message wherein if it is detected that the PC client bound with a hard terminal requests to hold the instant meeting, the meeting server establishes an instant meeting, and this call is not charged because the signaling channel is established for subsequent meeting control.

303, the meeting server notifies the PC client that the meeting is successfully established.

304, the meeting server inquires to obtain the number of the hard terminal bound with the PC client, and calls the number of the hard terminal to the core network.

305, the core network routes the call to the hard terminal bound with the PC client, and accesses the hard terminal into the meeting.

306, the meeting server sends a notify message to inform the PC client of the state information of the meeting and meeting members wherein when the meeting is successfully held, the client needs to subscribe the meeting information, after which the meeting server will send the state information of the meeting and meeting members to the client.

307, the PC client sends to the meeting server a refer add terminal request message which is an in-band message, and the channel is the signaling channel previously established.

308, after receiving the add terminal request, the meeting server sends to the core network an invite message for inviting the member to join the meeting.

309, the core network sends the invite message to the member terminal.

310, after the member terminal responds, the meeting server adds the member terminal into the meeting.

311, the meeting server sends a notify message to the PC client to inform the PC client of the state information of the current meeting and meeting members.

312, the PC client can continue to send other meeting control messages to the meeting server to control the meeting.

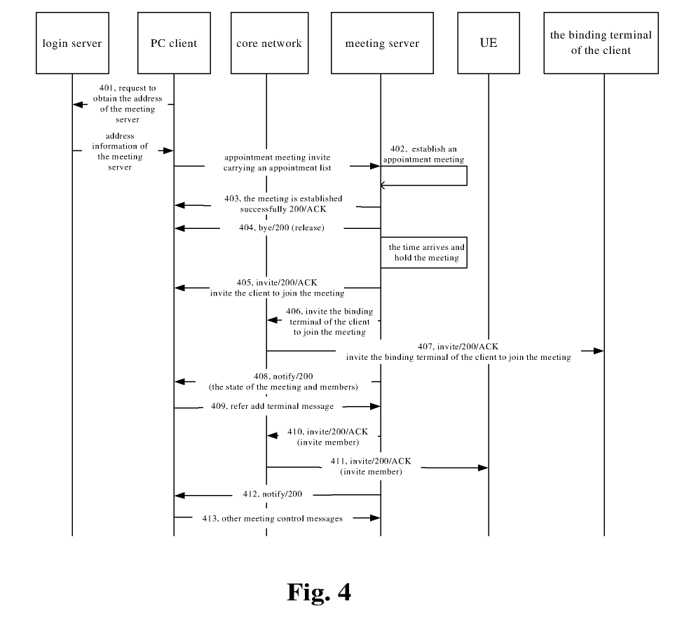

With reference to FIG. 4, FIG. 4 shows a flow of the method for holding an appointment meeting when the PC client is bound with a hard terminal according to one embodiment of the present invention. The method concretely comprises the steps as follows.

401, the PC client obtains the address information of the meeting server from the login server, and initiates an appointment meeting invite message to the meeting server according to the address information, wherein the invite message carries a member list.

402, the meeting server identifies the received appointment meeting invite message, wherein if it is detected that the PC client bound with a hard terminal requests to hold the instant meeting, the meeting server establishes an instant meeting, and this call is not charged because the signaling channel is established for subsequent meeting control.

403, the meeting server notifies the PC client that the appointment meeting is successfully established.

404, the meeting server releases the call.

405, when the time for the appointment meeting arrives, the meeting server sends to the PC client an invite message for inviting it to join the meeting so as to open up (get through) a meeting control channel to the PC client; and the PC client, after joining the meeting, can transmit a meeting control message on the signaling channel established by the invite message.

406, the meeting server inquires to obtain the number of the hard terminal bound with the client, and calls the number of the hard terminal to the core network.

407, the core network routes the call to the hard terminal bound with the PC client, and accesses the hard terminal into the meeting.

408, the meeting server sends a notify message to inform the PC client of the state information of the meeting and meeting members wherein when the meeting is successfully held, the client needs to subscribe the meeting information after which the meeting server will send the state information of the meeting and meeting members to the client.

409, the PC client sends to the meeting server a refer add terminal request message which is the in-band message, and the channel is the signaling channel established by the invite message in step 405.

410, after receiving the add terminal request, the meeting server sends to the core network an invite message for inviting a member to join the meeting.

411, the core network sends the invite message to another member terminal, and after the member terminal responds, the meeting server adds the member terminal into the meeting.

412, the meeting server sends a notify message to the PC client to inform the PC client of the state information of the current meeting and meeting members.

413, the PC client can continue to send other meeting control messages to the meeting server to control the meeting.

The embodiments above are only used to explain the technical solution of the present invention, but not used to restrict the present invention. The present invention is detailed only with reference to the preferable embodiments. What should be understood for those skilled in the art is that any amendments, equivalent substitutions to the technical solution of the present invention within the spirit and principle of the present invention are all concluded in the protection scope of the claims of the present invention.

### INDUSTRIAL APPLICABILITY

In the present invention, the PC client obtains the address information of the meeting server from the login server when the user logs in, and then directly establishes the signaling channel between the PC client and the meeting server according to the address information, so that the PC client can send the meeting control signaling message to the meeting server through the signaling channel to control the meeting, and the function of holding a meeting when the PC client is bound with a hard terminal can be realized.

1. A method for holding a meeting when the PC client is bound with a hard terminal, comprising:
the PC client obtaining address information of a meeting server from a login server;
establishing a signaling channel between the PC client and the meeting server according to the address information; and
the PC client sending a meeting control signaling message to the meeting server through the signaling channel to control the meeting.

2. The method according to claim 1, wherein the signaling channel is established in the following manner in which:
the PC client sends an instant meeting establishment request message to the meeting server according to the address information; and the meeting server establishes an instant meeting after receiving the instant meeting establishment request message, wherein the instant meeting establishment request message is used for establishing the signaling channel between the PC client and the meeting server.

3. The method according to claim 1, wherein the signaling channel is established in the following manner in which:
the PC client sends an appointment meeting establishment request message to the meeting server according to the address information; and the meeting server establishes an appointment meeting after receiving the appointment meeting establishment request message; and
when time for the appointment meeting arrives, the meeting server sends to the PC client a request message for inviting the PC client to join the meeting, and establishes the signaling channel between the PC client and the meeting server.

4. The method according to claim 1, further comprising:
the meeting server sending state information of the meeting and/or meeting members to the PC client through the signaling channel.

5. The method according to claim 1, wherein during the process that the PC client controls the meeting through the meeting server, the meeting server routes the control signaling message of the PC client to each meeting member through a core network.

6. A login server for holding a meeting when a PC client is bound with a hard terminal, wherein the login server is configured to provide the PC client with address information of a meeting server, so that the PC client is able to establish a signaling channel with the meeting server according to the address information, and send a meeting control signaling message to the meeting server through the signaling channel to control the meeting.

7. A PC client for holding a meeting when the PC client is bound with a hard terminal, wherein the PC client comprises an address obtaining module, the address obtaining module is configured to obtain address information of a meeting server from a login server, and the PC client is configured to establish a signaling channel with the meeting server according to the address information, and send a meeting control signaling message to the meeting server through the signaling channel to control the meeting.

8. A meeting server for holding a meeting when a PC client is bound with a hard terminal, wherein the meeting server is configured to establish an instant meeting/appointment meeting according to a request from the PC client, and control the meeting according to a meeting control signaling message from the PC client, wherein the address information of the meeting server is obtained from a login server by the PC client, so that the PC client establishes a signaling channel with the meeting server according to the address information.

9. The meeting server according to claim 8, wherein the meeting server is further configured to send to the PC client state information of the current meeting and/or meeting members through the signaling channel.

10. The method according to claim 2, further comprising:
the meeting server sending state information of the meeting and/or meeting members to the PC client through the signaling channel.

11. The method according to claim 3, further comprising:
the meeting server sending state information of the meeting and/or meeting members to the PC client through the signaling channel.

12. The method according to claim 2, wherein during the process that the PC client controls the meeting through the meeting server, the meeting server routes the control signaling message of the PC client to each meeting member through a core network.

13. The method according to claim 3, wherein during the process that the PC client controls the meeting through the meeting server, the meeting server routes the control signaling message of the PC client to each meeting member through a core network.
